(19) United States
(12) Patent Application Publication
(10) Pub. No.: US 2002/0121771 A1
(43) Pub. Date: Sep. 5, 2002

(54) Breakaway steering column support for a vehicle

(76) Inventors: David Shifflett, Rochester Hills, MI (US); Richard Lawrence Matsu, Plymouth, MI (US)

Correspondence Address: DOUGLAS J. McEVOY, Gifford, Krass, Groh, Sprinkle,, Anderson & Citkowski, P.C., 280 N. Old Woodward, Suite 400, Birmingham, MI, 48009, US

(21) Appl. No.: 09/797,814

(22) Filed: Mar. 2, 2001

(51) Int. Cl. B62D 1/16

(52) U.S. Cl. 280/779; 280/777

(57) ABSTRACT

A column support for use with a steering wheel and concentrically extending steering shaft of a vehicle. The vehicle further includes an occupant compartment defined in part by a dashboard and a floorboard. A generally elongate and internally hollowed tubular member is constructed of a grade steel material with first and second ends and through which extends the steering shaft. The first end of the tubular member terminates in a mounting bracket which secures the column support at a first location to the vehicle floorboard. A structural member is constructed of a second material and extends from an exterior of the tubular member at a selected location to its second end. The structural member includes first and second breakaway tabs at laterally extending mounting locations for securing said column support at a second location to an underside of the vehicle dashboard. The breakaway tabs each include a central collar portion through which is inserted an associated mounting fastener and a plurality of circumferentially arrayed apertures extending around the central collar portion. A plurality of weakened connecting portions alternate with the apertures and interconnect the central collar portion with the column support structural member such that, upon experiencing a determined forward momentum of the vehicle operator against the steering wheel, the collar portions fracture from the structural member and the structural member and associated steering wheel and steering shaft disengage from the vehicle dashboard.

### BACKGROUND OF THE PRESENT INVENTION

1. Field of the Invention

The present invention relates generally to steering column support devices and assemblies. More particularly, the present invention is a steering column support structure constructed of steel and plasticized material and incorporating weakened tabs at bolt mount locations for providing efficient breakaway of the support structure from its underside mounting location to the vehicle dashboard in the event of a vehicle collision and resulting forward momentum of the vehicle operator.

2. Description of the Prior Art

Collapsible steering column support devices are fairly well known in the art. The purpose for such shearable or detachable supports is to reduce or prevent injuries to the vehicle operator in the instance of a front-end collision.

U.S. Pat. No. 6,027,088, issued to Steadman et al., teaches a first type of plastic steering column support bracket for a vehicle. The device of Stedman is constructed of plastic, and includes a pair of laterally spaced apart side braces and a front brace interconnecting the front ends of the side braces. An intermediate brace is located between the front and rear ends of the side braces and an X-shaped truss is provided with legs extending diagonally between the side braces and between the intermediate brace and the rear ends of the side braces. Bolts rigidly secure the bracket to the upper dash panel of the vehicle and additional fasteners are provided for securing the collar on the steering column to the instrument panel.

A further example of a prior art and variable energy-absorbing steering column is illustrated in U.S. Pat. No. 6,170,874, issued to Fosse, and which includes a steering shaft and a steering column supporting the steering shaft, the steering column being displaceably mounted with respect to the stress-bearing structure. A first energy absorber is provided and absorbs energy upon displacement of the steering column with respect to the stress-bearing structure by the occupant. A sensor detects a condition in which the occupant is restrained by the seat belt and a second energy absorber absorbs energy upon displacement of the steering column with respect to the stress bearing structure by the vehicle occupant. A lock permits absorption of the energy by the second energy absorption unit by displacement of the steering column with respect to the stress bearing structure by the occupant when the condition is detected by the sensor.

U.S. Pat. No. 5,609,063, issued to Hedderly, teaches a steering column support for mounting an energy absorbing steering column within a motor vehicle includes a strap that extends transversely with respect to the steering axis (A) and has a central portion that mounts the steering column as well as having opposite ends each of which include a mounting portion for mounting on the vehicle. The support also includes a guide secured to the vehicle and which extends along a predetermined axis. The strap includes a hook disposed adjacent to the guide. Upon collapse of the steering column, along the steering axis A, deforms the strap to absorb energy while the hook engages the guide to direct the steering column to a predetermined orientation during the collapse of the steering column.

U.S. Pat. No. 5,979,860, issued to Jurik, teaches a steering column support apparatus with shearable ribs and in which the column is supported by a stationary wall that carries two capsules on either side of the steering column. The steering column has an attachment wall that extends within the capsules and each capsule has two support walls sandwiched around the attachment wall and a tubular connector joining the support walls together. Several of the ribs are integral with the tubular connector and in contact with edge areas of the attachment wall such that, in a crash situation, the steering column can collapse forwardly to minimize chest injury to the driver of the vehicle.

U.S. Pat. No. 5,819,592, issued to Lewandowski, teaches a steering column support structure having laterally spaced support flanges. A bracket on the steering column has bracket flanges and insulator pads are secured to the support flanges and connect to the bracket flanges. In response to a collision, the bracket flanges release in response to the collapse of the steering wheel in a frontal impact. The support flanges further have forward extensions providing ramps which engage the bracket flanges to prevent the steering column from rising during its collapse or during column stroke.

A yet additional example of a steering column support assembly is illustrated in U.S. Pat. No. 4,194,411, issued to Manabe. The Manabe reference teaches a support member jointed to a steering column to hold the column from below and includes planar opposite side portions with elongated grooves for receiving bolts for anchoring the support member to the vehicle body. Energy absorption is provided by a deformation promoting aperture extending in zigzag fashion and in parallel to the axis of the column provided between the support member and the vehicle body.

A final example of a steering column energy absorbing release bushing and deforming bracket is taught by U.S. Pat. No. 4,616,522, issued by White, and in which the column includes a tubular jacket supported from the vehicle body by upper and lower sheet metal brackets. The upper bracket is connected to the body by releasable capsules and the jacket has a plastic end cap bushing fitted on its forward end. The bushing is releasably press fitted in a concentric collar portion of the lower bracket and, under a predetermined impact loading on the steering wheel and column assembly, the capsules release the upper bracket to allow the column to be guided forwardly axially causing radial tabs on the bushing to be sheared-off in a first energy level absorption step. Continued travel of the column assembly in a controlled lateral path provides second higher level energy absorption wherein the lower bracket is deformed in a controlled manner.

### SUMMARY OF THE PRESENT INVENTION

The present invention discloses an improved energy-absorbable and detachable steering column support which provides forward deflection and detachment of the support and internally channeled steering column from an underside mounting location of a vehicle dashboard. The present invention further includes uniquely designed and weakened breakaway tabs which encircle underside mounting bolts and which are efficiently fractured upon the support column experiencing a measured degree of occupant induced forward momentum and so that the column support detaches and forwardly deflects in a direction away from the occupant.

The vehicle includes an occupant compartment defined in part by a dashboard and a floorboard. The vehicle also includes a steering wheel and journaled steering shaft. The steering column bracket includes a generally elongate and internally hollowed tubular member, through which the steering shaft is internally and concentrically channeled, and is constructed of a grade steel material with first and second ends. The first end of the tubular member terminates in a mounting bracket, in the form of a flanged portion and which includes first and second angled ends through which are inserted fasteners for securing the column support at a first location to the vehicle floorboard.

A structural member is constructed of a second material, typically a heavy duty and plasticized material, and is mechanically secured to the exterior of the tubular member so as to extend therefrom a selected location to its second end. The structural member also includes webbed portions defined along at least first and second sides and top of the structural member.

The structural member further includes first and second breakaway tabs at laterally extending mounting locations for securing said column support at a second location to an underside of the vehicle dashboard. The breakaway tabs each include a central collar portion through which is inserted an associated mounting fastener and a plurality of circumferentially arrayed apertures extending around the central collar portion. A plurality of weakened connecting portions alternate with the apertures and interconnect the central collar portion with the column support structural member such that, upon experiencing a determined forward momentum of the vehicle operator against the steering wheel, the collar portions fracture from the structural member and the structural member and associated steering wheel and steering shaft disengage from the vehicle dashboard.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of the column support according to the preferred embodiment of the present invention;

FIG. 2 is a first environmental view and generally illustrating the column support in mounting fashion within the vehicle interior;

FIG. 2a is a further environmental view in side perspective and illustrating, in phantom, the function of the breakaway tabs for enabling the column support to forcibly disengage and detach downwardly and pivotally from the dashboard underside;

FIG. 3 is an enlarged partial view of a breakaway tab according to the preferred embodiment of the present invention; and

FIG. 4 is a cutaway view taken along line 3-3 of FIG. 3 and showing the weakened interconnection defined by the alternating apertures and connecting portions and between the tab collar and the body of the structural member according to the present invention.

### DETAILED DESCRIPTION OF THE PREFERRED EMBODIMENTS

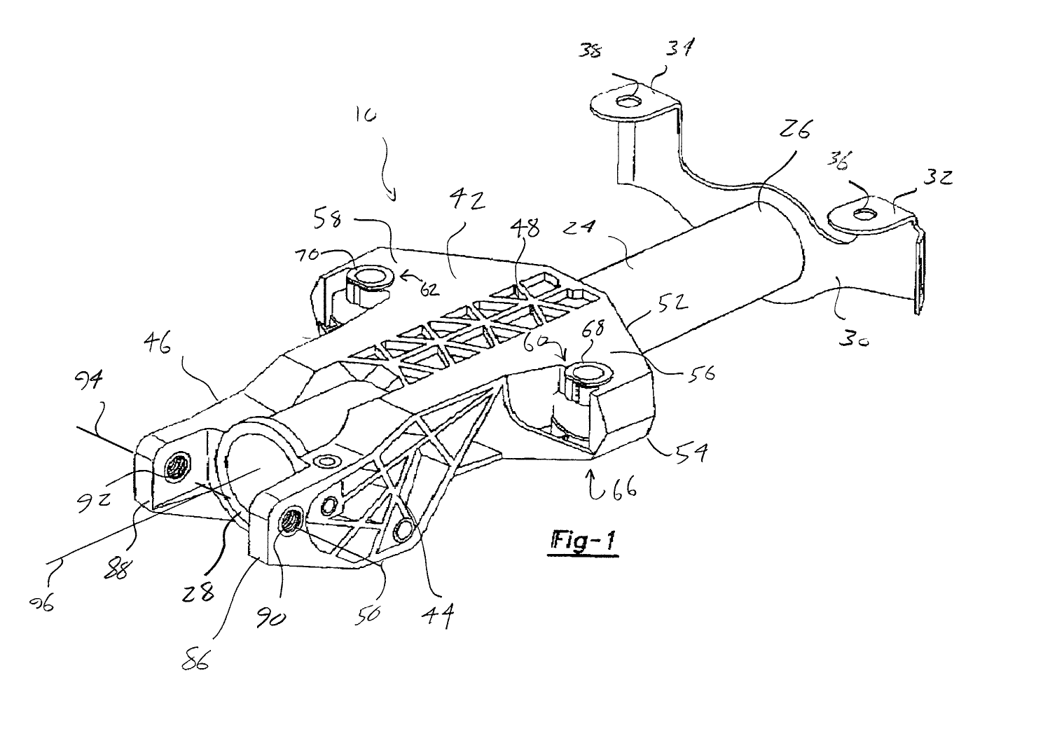

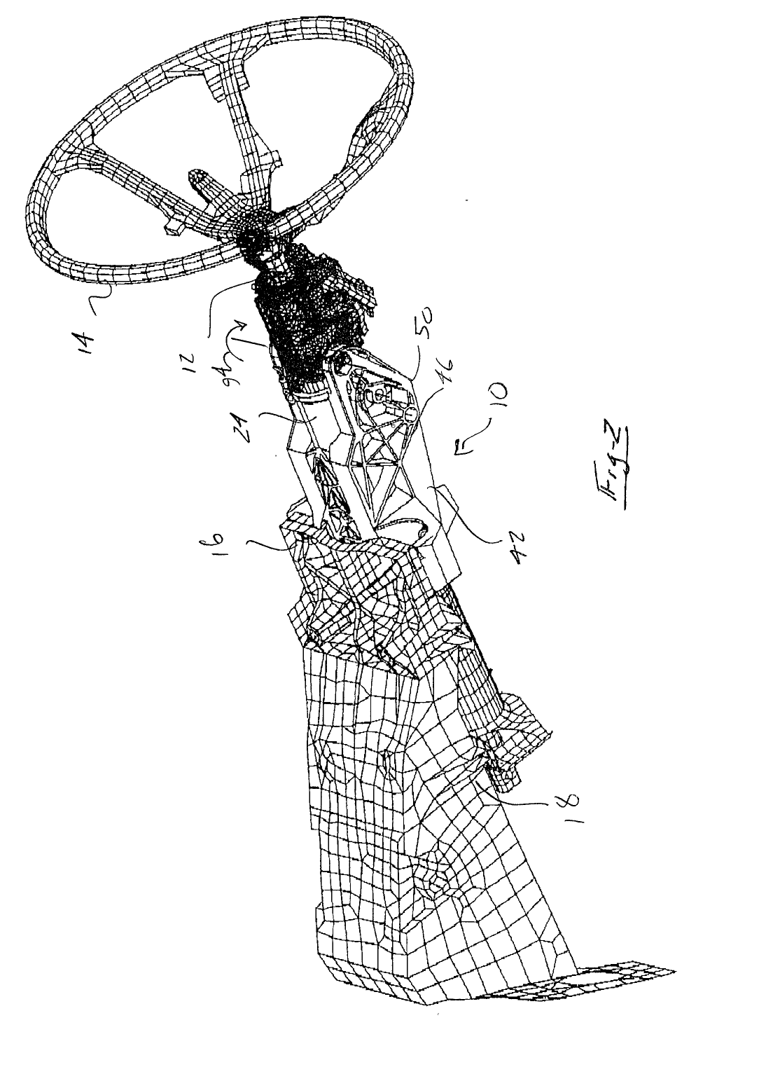

Referring now to FIG. 1, a column support is illustrated at 10 for use with a steering wheel and concentrically extending steering shaft (see at 12 for shaft in FIGS. 2 and 2a and further at 14 for steering wheel in FIG. 2) according to the present invention. As previously explained, the column support 10 discloses an improved energy-absorbable and detachable structure which provides forward deflection and detachment of the support and internally channeled steering column from an underside mounting location of a vehicle dashboard. The present invention further provides for efficient fracturing of the support column from the vehicle dashboard upon experiencing a measured degree of occupant induced forward momentum and so that the column support detaches in primarily an axially, forward direction away from the occupant.

Referring again to FIGS. 2 and 2a, the vehicle itself generally includes an occupant compartment defined in part by dashboard 16 and floorboard 18 locations. As is also generally known in the prior art, the steering wheel shaft 12 extends through the floorboard 18 (see again FIG. 2a) and into the engine compartment. As is further known in the relevant art, conventional automotive designs include shearable or deformable linkage connections between an extending end 20 of the steering wheel shaft 12 and the associated linkage mechanism (not illustrated) situated within the engine compartment. In this fashion, the steering shaft 12 and wheel 14 is permitted (independently from the function of the support column 10) to deflect in the fashion indicated by directional arrow 22.

Referring again to FIG. 1, the support column includes a generally elongate and internally hollowed tubular member 24 having first 26 and second 28 ends and through which extends the steering shaft 12 (see again FIGS. 2 and 2a). The tubular member 24 is preferably constructed of a grade steel material and with the first end 26 terminating in a mounting bracket which secures the column support 10 at a first location to the vehicle floorboard 18. The mounting bracket is illustrated at 30 in FIG. 1 and includes first 32 and second 34 inwardly turned tabs, within which are defined receiving apertures (36 and 38, respectively). Referring also to FIG. 2a, the representative side cutaway view also illustrates a bolt fastener 40 mounting through its associated tab 34 and aperture to secure to the floorboard 18.

A structural member 42 extends from an exterior of said tubular member 24 and from a selected location along the tubular member 24 to a location substantially at the second end 28 of the member 24. The structural member 42 is preferably constructed of a second material, usually a hardened plastic, nylon or plasticized composite. In a preferred construction, the structural member 42 defines an outer housing which is adhesively bonded (using an available and industrial grade adhesive for bonding plastic to metal) over the tubular member 24.

The structural member further includes webbed or ribbed portions, defined in an interlocking-lattice type fashion, and along at least first 44 and second 46 sides and a top 48 of the structural member 42. The pattern of the webs 44, 46 and 48 are such that they (as will be shortly described) optimize the efficient load transfer from the mounting to the column 10 attachment locations and variations may be introduced into the wall thicknesses of the structural member and so that material may be located where it is most needed.

A further axial location 50 of the outer structural member 42 defines a greater depth which, along with the selected webbed/ribbed patters 44, 46, 48, provides an enhanced degree of bending stiffness to reduce vertical vibration concerns. Additionally, top 52 and bottom 54 laterally spread locations (see also in phantom is side cutaway of FIG. 2a and which are understood to extend from both laterally extending sides of the member 42) are also constructed in a defined lattice-type arrangement (see lattice members 55) to provide a maximum quantity of material spread away from a neutral bending axis of the structural member 42 (as will again be subsequently described) and for a given amount of material.

Defined within the first and second laterally extending mounting locations of the structural member 42 (and as identified at 56 and 58 in FIG. 1) are first 60 and second 62 breakaway tabs for securing the column support 10 at a second location to an underside of the vehicle dashboard 16. First and second mounting fasteners (illustrated in phantom by fastener 64 in FIG. 2a) extend through underside inserting ends (see also at 66 in FIG. 1) of each breakaway tab 60 and 62 to secure the column support 42 to the underside of the vehicle dashboard 16.

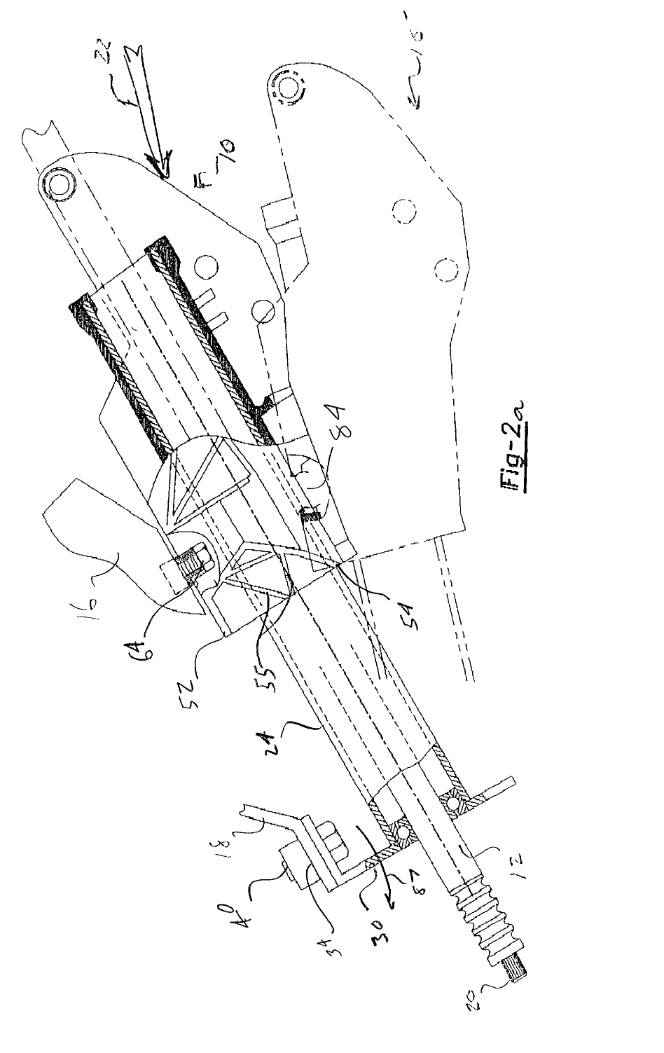

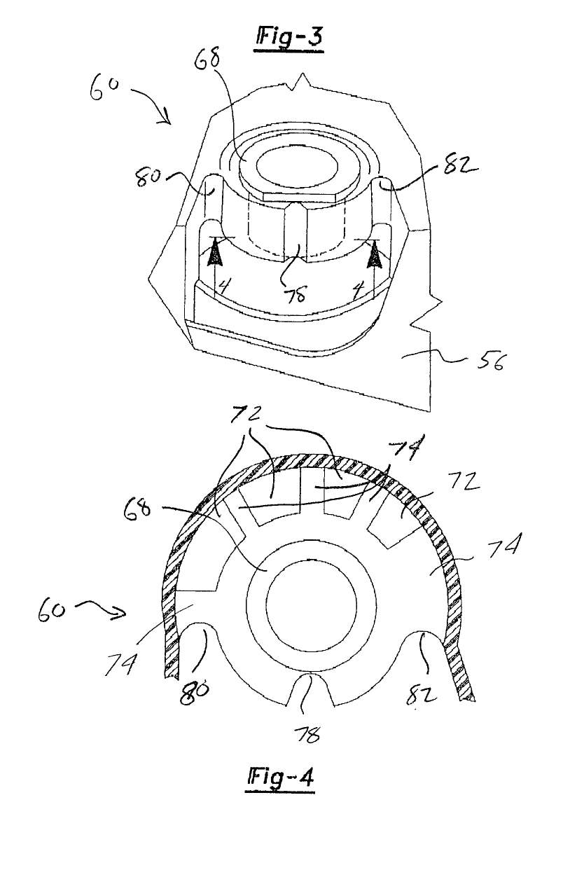

Referring also to FIGS. 3 and 4, the breakaway tabs 60 and 62 each further include a central collar portion (see at 68 and 70, respectively, for tabs 60 and 62 in FIG. 1) and through which is inserted the associated mounting fastener. In a preferred manufacturing operation, the central collar portions 68 and 70 can also be constructed of sleeve-shaped and grade steel material and may be insert molded within the plasticized body of the structural member 42.

Referring to the representative breakaway tab 60 illustrated in FIGS. 3 and 4, a plurality of circumferentially arrayed apertures 72 extend around the central collar portion 70. A plurality of weakened connecting portions 74 alternate with the array of aperture 72 and interconnect the central collar portion 70 with the remaining column support structure. Additional and arcuately formed and recessed structural areas are indicated at 78, 80 and 82, defined in a rear semi-circular range of the breakaway tab 60 in FIGS. 3 and 4, and which further assist in the frangibility of the tab 60. It is again understood that the construction of the other laterally extending and breakaway tab 62 is substantially as described with reference to breakaway tab 60 and, accordingly, repetitive illustration and description is not required.

Referring again to FIG. 2a, the breakaway aspects of the structural support column 10 are illustrated. Specifically, the column support 10 (with supported steering shaft 12 and steering wheel 14) is illustrated in a first mounted and intact position in which the mounting bracket end 30 is illustrated engaged to the floorboard 18 and the breakaway tabs 60 and 62 are likewise engaged at laterally spaced locations to the underside of the vehicle dashboard 16. Upon the occurrence of a determined forward momentum of the vehicle operator (not shown) and against the steering wheel 14, it is desirous that the column support 10 and associated steering shaft 12 and wheel 14 quickly and efficiently detach and disengage from at least the underside dashboard 16 location and before any serious injury results to the chest and rib areas of the vehicle operator.

Owing to the frangible/breakable nature of the tabs 60 and 62 (and by virtue of their manner of interconnection to the plasticized and structural member housing) the determined force impact will result in the first and second tabs 60 and 62 buckling and shearing. As best further illustrated at phantom illustration 84 in FIG. 2a, the collars 68 and 70 of the tabs are each disengaged from the laterally extending locations of the structural member 42 (owing to the shearing action exerted upon the circumferentially arrayed and weakened connecting portions 74) and remain mounted to the underside dashboard 16 while the detached structural member 42 with journaled steering shaft 12 and wheel 14 deflects axially, again in a fashion previously illustrated by directional arrow 20 and as shown in phantom at 10′, away from the user's upper body and torso and towards an area between the user's legs and proximate the floorboard of the vehicle. It is further contemplated that the construction of the breakaway tabs can be modified to vary the amount of momentum force necessary to axially shear and disengage from the underside dashboard location.

In this fashion, the likelihood of injury to the vehicle operator is greatly reduced. Furthermore, and as has been previously explained, the construction of the linkage connections within the engine compartment may further permit the shaft 12 and wheel 14 to axially deflect a measured distance in an inward/forward direction and towards the front end of the floorboard to provide an added measure of safety to the vehicle operator. Such inward/forward deflection would also contemplate a degree of bending force applied to the mounting bracket 30 (see arrow 87) to accommodate such forward momentum of the column support and steering mechanism. Alternately, the tubular member 24 may include telescoping first and second portions, (such second tubular portion, not shown, being slidably inserted within the outer main portion 24) and which permits the shaft 12 to forwardly deflect without bending of the bracket (at 87) and owing to such an inner tubular member connecting to bracket 30.

Referring again to FIG. 1, an additional feature of the column support 10 is described in reference to a pair of forwardly and includes substantially parallel extending portions 86 and 88, with corresponding aligning apertures 90 and 92 are defined in the extending portions 86 and 88. The apertures 90 and 92 define an axis 94 (see also FIG. 2) which is secondary to an axis of concentric rotation 96 of the steering shaft 12, and through which the steering wheel 14 is pivotally adjusted to a desired angle of inclination.

Having described our invention, additional preferred embodiments will become apparent to those skilled in the art to which it pertains and without deviating from the scope of the appended claims:

We claim:

1. A column support for use with a steering wheel and concentrically extending steering shaft of a vehicle, the vehicle further including an occupant compartment defined in part by a dashboard and a floorboard, said column support comprising:
a generally elongate and internally hollowed tubular member having first and second ends and through which extends the steering shaft, said first end terminating in a mounting bracket which secures column support at a first location to the vehicle floorboard;
a structural member extending from an exterior of said tubular member and from a selected location to said second end, said structural member including first and second laterally extending mounting locations for securing said column support at a second location to an underside of the vehicle dashboard; and
fracture means located at said laterally extending mounting locations for disengaging said structural member, and the associated steering wheel and steering shaft, from the vehicle dashboard upon experiencing a determined forward momentum of the vehicle operator.

2. The column support as described in claim 1, said fracture means further comprising first and second breakaway tabs, first and second mounting fasteners extending through first inserting ends of said breakaway tabs and securing to the vehicle dashboard.

3. The column support as described in claim 2, said breakaway tabs each further comprising:
a central collar portion through which is inserted said associated mounting fastener; and
a plurality of circumferentially arrayed apertures extending around said central collar portion, a plurality of weakened connecting portions alternating with said apertures, said weakened portions interconnecting said central collar portion with said column support structural member.

4. The column support as described in claim 1, said structural member further comprising webbed portions defined along at least first and second sides and a top of said structural member.

5. The column support as described in claim 4, each of said webbed portions further comprising an interconnecting lattice type framework.

6. The column support as described in claim 1, said tubular member and said mounting bracket being constructed of a first material and said extending structural member being constructed of a second material.

7. The column support as described in claim 6, said tubular member and said mounting bracket having a specified shape and dimension and being constructed of a specified grade steel.

8. The column support as described in claim 6, said structural member having a specified shape and dimension and being constructed of a heavy duty and plasticized material.

9. The column support as described in claim 1, said structural member further comprising a pair of forwardly and substantially parallel extending portions, aligning apertures being defined in said extending portions and defining an axis, secondary to an axis of concentric rotation of the steering shaft, and through which the steering wheel is pivotally adjusted.

10. A column support for use with a steering wheel and concentrically extending steering shaft of a vehicle, the vehicle further including an occupant compartment defined in part by a dashboard and a floorboard, said column support comprising:
a generally elongate and internally hollowed tubular member constructed of a first material and having first and second ends, through which extends the steering shaft, said first end terminating in a mounting bracket which secures column support at a first location to the vehicle floorboard;
a structural member constructed of a second material and extending from an exterior of said tubular member and from a selected location to said second end, said structural member including first and second breakaway tabs at laterally extending mounting locations for securing said column support at a second location to an underside of the vehicle dashboard; and
fracture means associated with said breakaway tabs for disengaging said structural member, and the associated steering wheel and steering shaft, from the vehicle dashboard upon experiencing a determined forward momentum of the vehicle operator.

11. A column support for use with a steering wheel and concentrically extending steering shaft of a vehicle, the vehicle further including an occupant compartment defined in part by a dashboard and a floorboard, said column support comprising:
a generally elongate and internally hollowed tubular member constructed of a first steel grade material and having first and second ends, through which extends the steering shaft, said first end terminating in a mounting bracket receiving mounting fasteners there through and which secures said column support at a first location to the vehicle floorboard;
a structural member constructed of a second heavy duty and plasticized material and extending from an exterior of said tubular member, from a selected location and to said second end;
said structural member including first and second breakaway tabs at laterally extending mounting locations for securing said column support at a second location to an underside of the vehicle dashboard, said breakaway tabs each including a central collar portion through which is inserted said associated mounting fastener and a plurality of circumferentially arrayed apertures extending around said central collar portion, a plurality of weakened connecting portions alternating with said apertures and interconnecting said central collar portion with said column support structural member; and
upon experiencing a determined forward momentum of the vehicle operator against the steering wheel, said collar portions of said breakaway tabs fracturing from said structural member, said structural member, and the associated steering wheel and steering shaft, disengaging from the vehicle dashboard.
